(19) United States
(12) Patent Application Publication
(10) Pub. No.: US 2014/0074492 A1
(43) Pub. Date: Mar. 13, 2014

(54) SYSTEMS AND METHODS FOR GENERATING AND MANAGING A HYBRID FORMULARY

(71) Applicant: Paul Momita, San Diego, CA (US)

(72) Inventor: Paul Momita, San Diego, CA (US)

(73) Assignee: MEDIMPACT HEALTHCARE SYSTEMS, INC., San Diego, CA (US)

(21) Appl. No.: 13/612,586

(22) Filed: Sep. 12, 2012

(51) Int. Cl. G06Q 50/22; G06Q 40/08

(52) U.S. Cl. 705/2

(57) ABSTRACT

Systems and methods for generating and managing a hybrid formulary for claims adjudication. In an embodiment, a plurality of source formulary components are received. Each of the plurality of source formulary components comprises one or more drug entries and/or one or more utilization management rules. A configuration is also received. The configuration comprises a plurality of component identifiers and one or more hierarchy rules. Each of the plurality of component identifiers identifies one of the plurality of source formulary components. The one or more hierarchy rules are applied to the identified source formulary components to generate a hybrid formulary. The hybrid formulary comprises a plurality of drug entries and/or one or more utilization management rules, which can be used for claims adjudications, reporting, or any other downstream formulary application.

### BACKGROUND

1. Field of the Invention

The present invention relates generally to prescription drug benefits programs, and, more particularly, to the generation and utilization of a hybrid formulary comprising at least portions of multiple formularies.

2. Related Art

Conventional systems for electronic claims adjudication by pharmacy benefits management (“PBM”) companies have been around for some time. A PBM is an administrator of prescription drug benefits programs. PBMs are primarily responsible for adjudication and paying claims for covered prescription drugs that are purchased by consumers who are members of the prescription drug benefits program. Other typical PBM services include developing and maintaining the drug formulary (the list of drugs covered by the prescription drug benefits program and their associated tiers), contracting with pharmacies, and negotiating discounts and rebates with drug manufacturers.

Conventional PBM claim adjudication systems are typically employed when a member attempts to purchase a drug and the drug purchase is to be wholly or partially covered by a prescription drug benefits program. A prescription drug benefits program may be provided to the member through an employer health plan (e.g., ERISA plans, self-insured employer group plans, managed care plans, Taft-Hartley trust plans, etc.), a privately purchased health plan, a government sponsored health plan (e.g., Medicare, Medicaid, or any other city, state, local, or federal government plan), or directly from a PBM provider.

In a typical drug purchase transaction, the originating entity (e.g., a pharmacy) electronically transmits a claim through a switch company to the PBM for adjudication of the claim. The PBM adjudicates the claim to validate, among other things, that the member prescription drug benefits program is valid, that the prescribing doctor is valid, and that the drug to be purchased is covered by the prescription drug benefits program. The PBM sends an electronic response back to the pharmacy that either denies the transaction or approves the transaction. If the transaction is approved, the response may comprise additional information, such as a co-pay amount.

Drug formularies today are typically developed and managed by a single entity. The formulary may be developed and managed by a PBM company or by a customer of the PBM company (e.g., an ERISA plan, self-insured employer group plan, managed care plan, Taft-Hartley trust plan). A committee of the PBM, customer, or other entity may be charged with developing, managing, updating, and administering a formulary. The committee may comprise primary care physicians, specialty physicians, pharmacists, nurses, legal experts, administrators, and/or other professionals in the healthcare field, and is often independent of the benefit plan sponsor and vetted for conflicts of interest. The committee may also design and implement utilization management rules, such as quantity limits, step therapy, prior authorizations, and the like.

Many customers of a PBM company use a tiered design, whereby each drug in the formulary is assigned to a tier. The tier represents the level of coverage provided by the benefits program. The most cost-effective drugs (e.g., generics) are generally assigned to the most preferred tier and have the lowest patient out-of-pocket costs (i.e., co-pays). Conversely, the least cost-effective drugs are generally assigned to the least preferred tier and have the highest co-pays, or are not covered (e.g., excluded from the formulary). During claim adjudication, the formulary is consulted to determine whether or not a particular drug is covered, what utilization management rules may apply, and which program tier is associated with the drug.

In some instances, it is beneficial to utilize two or more different formularies, which may be from different sources. For example, one source may be stronger or have greater expertise in one area or specialty, whereas another source may be stronger or have greater expertise in a different area or specialty. Additionally, a client of a PBM may wish to utilize a base formulary (e.g., supplied by the PBM), but adjust or override particular components of the base formulary, such as enhanced coverage, over-the-counter drugs, and the like.

The different source formularies may comprise overlapping and conflicting drug coverage, utilization management rules, and/or tiers. Accordingly, the components of the source formularies cannot simply be independently consulted based on the drug which is the subject of adjudication, since different components may apply conflicting utilization management rules and/or result in different tiers for the drug. In addition, one or more of the source formularies may be updated or otherwise modified quite frequently (e.g., daily, weekly, monthly, etc.). Accordingly, the components of the source formularies cannot simply be merged. Due to the frequent updates of the source formulary or formularies, a merged formulary, based on those formularies, would quickly become out-of-date. What is needed are systems and methods that overcome these present obstacles to the utilization of multiple formularies.

### SUMMARY

Accordingly, systems and methods are disclosed for overcoming these obstacles and congruently utilizing multiple incongruent formularies for claims adjudication.

In an embodiment, a method of managing a hybrid formulary for claims adjudication is disclosed. The method comprises, by at least one hardware processor: receiving a plurality of source formulary components, wherein each of the plurality of source formulary components comprises one or more drug entries and/or one or more utilization management rules; receiving a configuration comprising a plurality of component identifiers and one or more hierarchy rules, wherein each of the plurality of component identifiers identifies one of the plurality of source formulary components; and applying the one or more hierarchy rules to the identified source formulary components to generate a hybrid formulary, wherein the hybrid formulary comprises a plurality of drug entries and/or one or more utilization management rules.

In an additional embodiment, a system for managing a hybrid formulary for claims adjudication is disclosed. The system comprises: at least one hardware processor; and at least one executable software module that, when executed by the at least one hardware processor, receives a plurality of source formulary components, wherein each of the plurality of source formulary components comprises one or more drug entries and/or one or more utilization management rules, receives a configuration comprising a plurality of component identifiers and one or more hierarchy rules, wherein each of the plurality of component identifiers identifies one of the plurality of source formulary components, and applies the one or more hierarchy rules to the identified source formulary components to generate a hybrid formulary, wherein the hybrid formulary comprises a plurality of drug entries and/or one or more utilization management rules.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings, in which like reference numerals refer to like parts and in which:

FIG. 1 illustrates a process for generating or updating a hybrid formulary, according to an embodiment;

FIG. 2 illustrates a system for generating and/or managing a hybrid formulary, according to an embodiment;

FIG. 3 illustrates a network diagram of an example system for claims adjudication, according to an embodiment; and

FIG. 4 illustrates an example processing device that may be used in connection with various embodiments described herein.

### DETAILED DESCRIPTION

Certain embodiments disclosed herein provide for the combination of two or more drug formularies into a single, “hybrid” formulary, which leverages the strengths of each source formulary while resolving conflicts between the source formularies. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

A plurality of different entities may develop and maintain their own formularies. For example, these entities may include PBMs, clients of PBMs (e.g., ERISA plans, self-insured employer group plans, managed care plans, Taft-Hartley trust plans), and any other entity capable of developing and maintaining a formulary. A formulary may comprise one or more components. Each component can comprise a grouping of one or more drugs, which is sometimes called a “drug bucket.” Each component may also be associated with one or more attributes, which may include tiers associated with drugs or subsets of drugs within the component, utilization management rules which apply to drugs or subsets of drugs within the component, and the like.

In an embodiment, a user interface is provided for generating or editing a configuration for a hybrid formulary to be generated or updated. The user interface may be a web-based user interface, such as a webpage or set of webpages which utilize HyperText Markup Language (HTML), and may be either static, dynamically-generated, or comprise both static and dynamically-generated components. The user interface may be hosted on one or more web servers or other servers, and may be served by the servers over one or more networks (e.g., the Internet) using standard communications protocols (e.g., Hypertext Transfer Protocol (HTTP), Secure HTTP (HTTPS), and the like). The user interfaces may include one or more types of content, such as inputs, web forms, images, text, hyperlinks, and the like. A user may interact with the user interface using the inputs included in the user interface. These inputs may include buttons, checkboxes, radio buttons, text boxes or areas, references (e.g., hyperlinks), scroll bars, drop-down boxes, file uploads, and the like. Information, such as requests and/or data, may be transmitted from the user to the server(s) using standard communication protocols and request methods, including standard POST and GET methods. Likewise, responses to these requests may be transmitted from the server(s) to the user using the same standard communication protocols. Data, including system data, formulary data, configuration data, user data, and the like, can be stored in one or more files, directories, databases, or other data structures that are either locally or remotely accessible by the server(s). Users may communicate with the one or more servers via the user interface utilizing any suitable user devices, including without limitation desktop computers, laptop computers, tablet computers, and mobile communication devices, such as a smart phone or other mobile phone.

The user interacts with a user interface provided by user interface module 52 to generate or edit and approve one or more configurations, which may be saved in the database(s). A configuration can comprise identifiers of two or more source components and a set of hierarchy rules which define the hierarchy that should be applied to the source components. It should be understood that the source component identifiers may comprise a formulary identifier and a component identifier, or solely a component identifier which uniquely identifies the component from components of other source formularies. It should also be understood that a component identifier may identify an entire source formulary or any portion or content of the source formulary. For example, a source formulary may comprise a plurality of drug buckets (i.e., related groupings of drugs), and the component identifier may identify all of the drug buckets or a subset comprising less than all of the drug buckets. It should be understood that this is simply an example, and a formulary may be divided into modules other than drug buckets.

The set of hierarchy rules are defined to resolve potential conflicts that may arise due to overlap between the multiple source formularies (e.g., overlapping drug buckets and/or utilization management rules). In other words, for source formularies A and B, if an adjudication of a particular prescription according to formulary A would result in a different response than an adjudication according to formulary B, the hierarchy rules would define which source formulary's drug coverage and utilization management rules are applied for the adjudication. For example, the hierarchy rules may state that if such a conflict exists, formulary B′s drug coverage and utilization management rules should be applied. In this manner, the hierarchy rules can be used to ensure that only one response results for any given adjudication.

As a further illustrative and non-limiting example, source formularies A, B, and C may each comprise coverage, including a quantity limit, for drugs D₁ and D₂. Formulary A may comprise components A₁, A₂, and A₃, of which component A₁ specifies the quantity limit L_{1A} for D₁ and component A₂ specifies the quantity limit L_{2A} for D₂. Formulary B may comprise components B₁, B₂, B₃, and B₄, of which component B₁ specifies the quantity limit L_{1B} for D₁ and component B₂ specifies the quantity limit L_{2B} for D₂. Formulary C may comprise components C₁ and C₂, of which component C₁ specifies the quantity limit L_{1C} for D₁ and component C₂ specifies the quantity limit L_{2C} for D₂ The configuration may indicate that hybrid formulary H should be composed of components A₁, A₂, B₁, B₂, B₃, B₄, and C₁. The configuration may also specify hierarchy rules which provide that conflicts between formularies A and B should be resolved in favor of formulary B, that conflicts between formularies A and C should be resolved in favor of formulary C, and that conflicts between formularies B and C should be resolved in favor of formulary C.

In the above scenario, during the hybridization process, components A₁, A₂, B₁, B₂, B₃, B₄, and C₁ will be obtained or extracted from formularies A, B, and C. Since components A₁, B₁, and C₁ each include a quantity limit for D₁, the hierarchy rules must be applied to determine which quantity limit should be used for the hybrid formulary H. Since the rules specify that conflicts should be resolved in favor of formulary C over formulary B and over formulary A, a hybrid component H₁ should be generated which specifies quantity limit L_{1C} for drug D₁. In addition, since components A₂ and B₂ each include a quantity limit for D₂, the hierarchy rules must again be applied. Notably, since C₂ is not indicated in the configuration, quantity limit L_{2C} does not present a conflict. In this case, since the rules specify that conflicts should be resolved in favor of formulary B over formulary A, a hybrid component H₂ should be generated which specifies quantity limit L_{2B} for drug D₂. In other words, quantity limit L₂c was carved out by the identification of the content in the configuration, and quantity limit L_{2A} was carved out by the hierarchy rules, such that only quantity limit L_{2B} remains to be included in the hybrid formula. Furthermore, assuming components B₃ and B₄ do not present any conflicts with components A₁, A₂, and C₁, they can be used to generate hybrid components H₃ and H₄ without any need for conflict resolution. Accordingly, hybrid formulary H is generated and comprises components H₁, H₂, H₃, and H₄, of which component H₁ specifies quantity limit L₁c for drug D₁ and component H₂ specifies quantity limit L_{2B} for drug D₂. It should be understood that this is but one simple example for the purposes of illustration. In practice, there may be more or less source formularies, multiple conflicts between source components, significantly more complex and/or more granular hierarchy rules (e.g., component-level rules, drug-level rules, etc.), less modularized hybridization of components, etc.

The user interface can comprise a wizard or other series of interfaces which guides a user through a series of questions, steps, queries, prompts, selections, choices, or other interactions to create or modify a configuration, including selecting the source formularies, selecting components of the source formularies, and/or defining the hierarchy rules. The series of interfaces may be designed to ensure that all potential conflicts between the selected source components are associated with at least one rule that resolves the conflict. For example, the series of interfaces may be designed to provide increasing levels of granularity or detail with respect to hierarchy rules. For instance, at a high level, the user may specify a source-based rule which always favors one source formulary over other source formularies. If the user does not specify such a rule or if the specified rules do not resolve all potential conflicts, the user interface may provide the user with inputs to define one or more component-based rules, e.g., a hierarchy rule which favors one source's drug bucket over other sources' drug buckets. Again, if no such rules are specified by the user or if the specified rules do not resolve all potential conflicts, user interfaces can be provided to guide the user through one or more additional levels of granularity until sufficient hierarchy rules are specified to provide for resolutions of all potential or anticipated conflicts. The wizard can also ensure that no conflicting rules are created by preventing the specification of such rules in the first place or notifying the user of identified conflicts. In the event that a configuration is modified (e.g., a source formulary is added or deleted), the user interfaces may guide the user through all or a portion of the rule screens again to update the hierarchy rules in response to the modification.

In an embodiment, once a configuration is generated, and optionally approved, it is used to generate and/or maintain a hybrid formulary. If a new hybrid formulary is desired, the user can utilize the user interface to generate a new hybrid formulary in accordance with the configuration. That is, the set of hierarchy rules in the configuration are applied to the plurality of source formulary components identified in the configuration to generate a new hybrid formulary. Additionally, the user may use the configuration to update an existing hybrid formulary, for instance, because of a change to a source component or a change to the configuration.

In an embodiment, the configuration is applied to source formulary components periodically to update the hybrid formulary. Such periodic applications of the configuration ensure that the hybrid formulary reflects changes to any of the source formulary components. The frequency of the updates can be predetermined (e.g., a set time or duration, such as daily, weekly, monthly, etc.), manual (e.g., when requested by a user), and/or automatic in response to a change in a source formulary or component. For example, according to one embodiment, the server(s) may execute an application or module which monitors the source formularies. This monitoring may comprise receiving a notification of, or otherwise detecting (e.g., via a request, version monitoring, etc.), a change to a source formulary or component. In response to the detection, the module can update or initiate updating of the hybrid formulary in accordance with the configuration to reflect the change(s) in the source component(s). In an embodiment, these updates can be initiated automatically without human intervention.

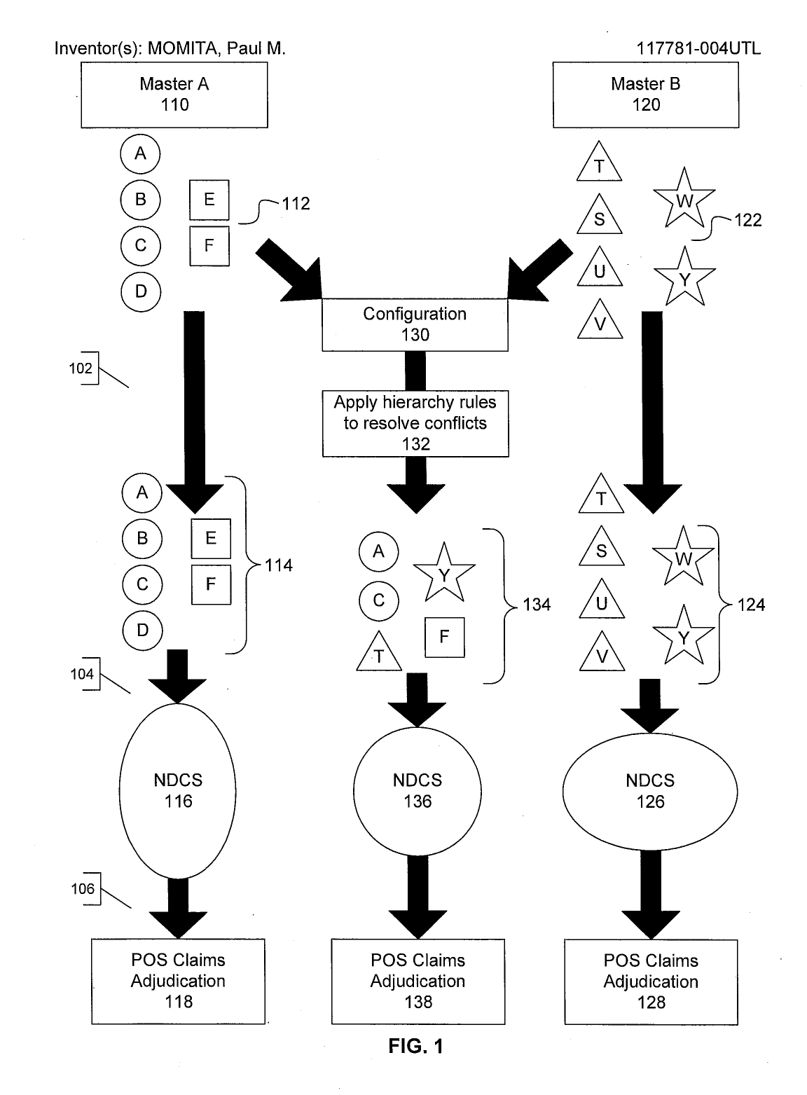

FIG. 1 is a high-level diagram illustrating the process of generating or updating a hybrid formulary, according to an embodiment. Initially, there is a plurality of formulary templates or “masters,” each associated with and defining a source formulary. While the illustrated embodiment only shows two such masters (110 and 120) and corresponding source formularies, it should be understood that the illustrated process can be used with any number of masters and source formularies. Each master 110 and 120 comprises or is associated with one or more drug buckets (i.e., groupings, definitions, or other indications of drugs) 112 and 122, respectively. Each master can also be associated with one or more utilization management rules (not shown). These drug buckets and/or utilization management rules may be arranged in tiers or other hierarchy. In addition, each master 110 and 120 may have a different owner and/or be defined using a different drug language (e.g., First Databank (FDB), Medi-span, etc.)

In step 102, the configuration 130, as described above, is applied to the source formulary templates/masters 110 and 120 and associated drug buckets 112 and 122 to generate a hybrid formulary 134. As discussed above, configuration 130 comprises rules for inclusion and/or exclusion of drugs and/or drug buckets from the masters 110 and 120, rules for tiering the drugs in drug buckets 112 and 122, and, if applicable, hierarchy rules to resolve any conflicts or overlap in drug coverage, tiering, and the like. For instance, in step 132, hierarchy rules may be applied to resolve conflicts in drug inclusions, tiers, and utilization management rules. Accordingly, as shown, the hybrid formulary may comprise mixed and/or overlapping subsets of components (e.g., drug buckets, utilization management rules, etc.) from each source formulary. As with the masters, these components may be arranged in tiers or other hierarchy.

Additionally, in an embodiment, the masters 110 and 120 are configured into individual formularies 114 and 124, respectively. These configurations may be performed by the same system (e.g., server(s)) which configures the hybrid formulary, by a different system, or each by different systems. For instance, each of formularies 114, 124, and 134 may be managed by the same PBM, in which case they may all be configured on the same system. Alternatively, one or more formularies may be managed by different entities, in which case they may be configured by the systems of their respective entities.

In step 104, in an embodiment, the hybrid formulary is expanded into a formulary 136 comprising the National Drug Code (NDCs) for each drug included in the hybrid formulary. This process translates the higher level drug entities used to define the formulary into the specific NDCs associated with the formulary. The same expansion/translation may be performed for the individual source formularies as well to generate source formularies 116 and 126.

In step 106, the hybrid formulary 136 is extracted or loaded (e.g., by a PBM) for pharmacy point-of-sale (POS) claim adjudications. Using the hybrid formulary, a PBM can combine components of multiple source formularies, while resolving any conflicts to correctly adjudicate a drug request at the proper tier using the appropriate utilization management rules. In an embodiment, the individual source formularies may also be extracted or loaded by the same entity or a different entity or entities for claim adjudications.

The process illustrated in FIG. 1 can be applied periodically and/or each time a source formulary or source formulary master (e.g., 110, 120) is modified. Modifications may include changes to the drug buckets and/or utilization management rules associated with the source masters (e.g., 110, 120). For example, by way of illustration and not limitation, such modifications may include the addition and/or removal of drugs and/or drug buckets to the master, changes in dosage levels of a drug, changes in the form of a drug (e.g., pill to liquid or vice versa), changes in a formulation and/or strength of a drug, changes in a quantity limit for a drug, changes in tiers for a drug (e.g., changes in co-pays, and the like), etc.

Furthermore, the process illustrated in FIG. 1 can be applied to produce more than one hybrid formulary. For example, different configurations can be applied to the same set of formulary masters and/or the same configuration rules can be applied to different sets of source formulary masters to produce a plurality of hybrid formularies. A plurality of hybrid formularies may be useful in cases where a PBM has multiple clients which desire or specify different combinations of source formularies.

In an embodiment, once the hybrid formulary 136 or formularies are created, they can be utilized for POS claims adjudication, reporting, or any other downstream formulary application, in the same manner as any other formulary (e.g., the source formularies 116 and 126). In other words, the adjudication process 138 does not have to be modified to accommodate the hybrid formulary 136, and may be identical or similar to the adjudication processes 118 and 128 for the source formularies, or any conventional adjudication process.

However, in an embodiment, for auditing or other purposes, the drugs and/or utilization management rules within the hybrid formulary 136 may comprise tags to identify the source formulary from which the drug or utilization management rule was derived. For example, returning to the scenario described above, hybrid formulary H may comprise components H₁, H₂, H₃, and H₄, of which component H₁ specifies quantity limit L_{1C} for drug D₁ and component H₂ specifies quantity limit L_{2B} for drug D₂. In this case, the quantity limit L_{1C} can be tagged or otherwise associated with an indication that this utilization management rule was derived from source formulary C. Alternatively or additionally, drug D₁ can be tagged or otherwise associated with such an indication. Similarly, the quantity limit L_{2B} and/or drug D₂ can be associated with indications of their derivation from source formulary B. Thus, whenever a claim adjudication is processed, a source formulary identifier can be associated with each response or outcome of the claim adjudication. This association can occur by subsequently replaying the claim adjudication to determine which coverages and utilization management rules were applied to obtain the prior outcome. Alternatively, the association can be made by analyzing the hierarchy rules in the configuration that was used to generate the hybrid formulary to determine which source formulary's components were used to achieve the outcome. As an additional alternative, the identification(s) of the source formularies from which the outcome was derived can be made at the time of claim adjudication, and this identification(s) can be directly associated with the outcome (e.g., by storing the association in a database during or after the corresponding claim adjudication). In an additional embodiment, source identification may be stored as part of the definition and update of the hybrid formulary itself. In an embodiment, these identifiers are used internally and not operationally, and therefore, are not transmitted or known to the requesting pharmacy or other entity. In this manner, a user or operator can more easily identify how an outcome was achieved for debugging, auditing, or other reporting or notification purposes.

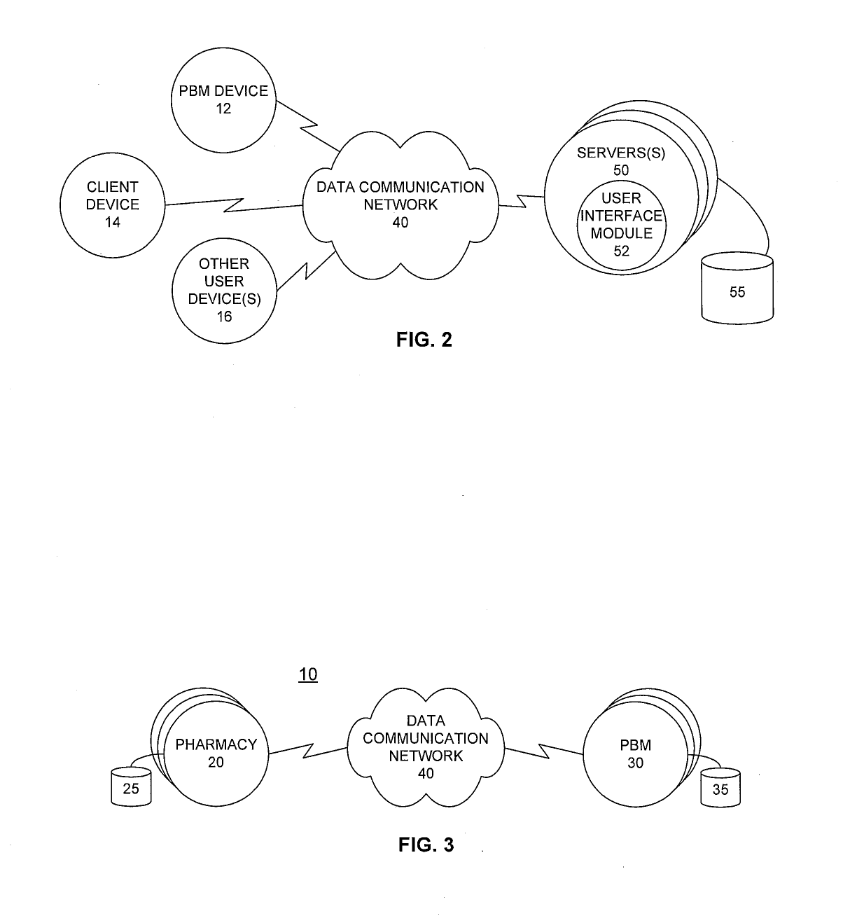

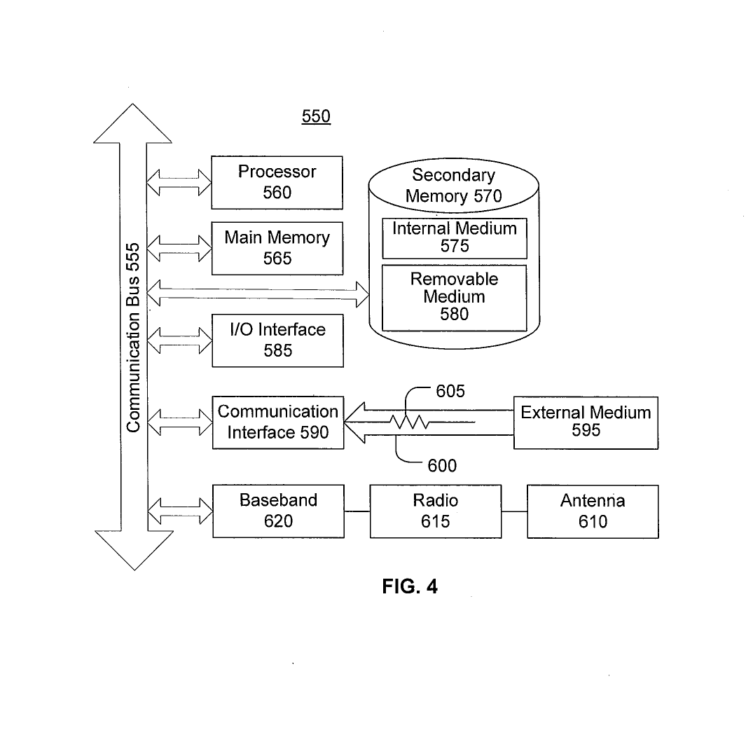

FIG. 2 illustrates a system for generating and managing a hybrid formulary, according to an embodiment. One or more servers 50 may host and execute the software and/or manage the data (e.g., stored in database(s) 55) for generating and managing the hybrid formulary in the manner described herein. For instance, the server(s) 50 may provide a user interface module 52, which serves the user interface(s) described herein to one or more user devices. For example, user device 102 may be utilized by a PBM. Alternatively or additionally, user device 104 may be utilized by a client of the PBM, which may be collaborating with the PBM on a hybrid formulary, or which may have partial or sole responsibility for a hybrid formulary. It should be understood that these examples are merely illustrative, and that other user device(s) 106 may interact with the user interface module 52 of server(s) 50. Example architectures that can be employed for such user devices are described later with respect to FIG. 4.

FIG. 3 illustrates a network diagram of a claims adjudication system, which may be used for adjudicating claims according to a hybrid formulary. The system 10 comprises a pharmacy 20 that is communicatively coupled with PBM 30 via a data communication network 40, which may include the Internet. The system 10 may include more than one pharmacy 20 and more than one PBM 30.

The pharmacy 20 can be a brick-and-mortar store, an online ecommerce website or application, or any other sort of entity, system or device that is capable of handling a member's prescription drug purchase transaction. The pharmacy 20 may include one or more processor-enabled communication devices (not shown) that are capable of communicating with the PBM 30 over the network(s) 40 and storing data in and retrieving data from the data storage area 25. The data storage area 25 may include any form of memory, including volatile and non-volatile memory. In one embodiment, the data storage area 35 includes non-transitory computer-readable media. Example architectures that can be employed for such communication devices are described later with respect to FIG. 4.

Similarly, the PBM 30 may include one or more processor-enabled communication devices (not shown) that are capable of communicating with the pharmacy 20 over the network(s) 40 and storing data in and retrieving data from the data storage area 35. The data storage area 35 may include any form of memory, including volatile and non-volatile memory. In one embodiment, the data storage area 35 includes non-transitory computer-readable media. Example architectures that can be employed for such communication devices are describe later with respect to FIG. 4.

The network(s) 40 may include a variety of communication infrastructure, including without limitations, direct wired connections, personal area networks, local area networks, wide area networks, metropolitan area networks, telephone networks, the Internet, and any other communication infrastructure. The network(s) 40 may be wired or wireless and may also be capable of transmitting voice or data traffic or a combination of voice and data traffic. The network(s) 40 may also be public or private or a combination of public and private, and may transmit information using a variety of protocols, as is understood by those skilled in the art.

In one embodiment, the data communication network(s) 40 include a switch (not shown) that operates in the communication infrastructure between the pharmacy 20 and the PBM 30 and serves to electronically route prescription drug purchase claims to the appropriate PBM 30 based on member-provided information (e.g., a prescription drug benefits program card, or other eligibility data or evidence of coverage).

In operation of the system 10, a member of a prescription drug benefits program attempts to purchase a prescribed drug at the pharmacy 20. The pharmacy 20 collects certain information from the member to validate the prescription drug purchase transaction (also referred to herein as a “claim”). For example, this information may be obtained from the member's prescription drug benefits program card or health plan card. The pharmacy 20 sends an electronic claim adjudication request to the PBM 30 via the network(s) 40. The claim adjudication request seeks approval of the drug purchase transaction from the PBM 30. The PBM 30 adjudicates the claim based on the request and a hybrid formulary to validate or determine various elements related to the claim. For example, these elements related to the claim may include, without limitation, enrollment status of the member in the prescription drug benefits program, other member information, inclusion of the drug to be purchased on the hybrid formulary, the quantity of the drug to be purchased (e.g., as limited by the utilization management rules of the hybrid formulary), the amount of the member co-pay (e.g., as determined by consultation of the hybrid formulary), benefit design, pharmacy network, other restrictions imposed by the utilization management rules of the hybrid formulary, etc.

During claim adjudication, the PBM 30 analyzes information relevant to the particular claim being adjudicated. During the analysis, the PBM 30 determines, at least in part based on a formulary (e.g., hybrid formulary 134, or source formulary 114 or 124), whether the claim will be denied or approved. If the claim will be approved, the PBM 30 further utilizes the formulary to determine the tier at which the claim will be adjudicated. If the claim will be denied, in some embodiments, the PBM 30 may determine if the tier level will be overridden. Upon completion of the claim adjudication process, the PBM 30 provides the results of the claim adjudication to the pharmacy 20 in response to the claim adjudication request.

The systems and methods disclosed herein may be used to generate a hybrid formulary for claims adjudication for prescription drug benefits programs. It should be understood that embodiments of the hybrid formulary generation and management processes and systems may be used in conjunction with any claims adjudication process or system. For instance, some embodiments of the disclosed systems and methods may be used in conjunction with the systems and methods disclosed in U.S. patent application Ser. No. 12/913,685, entitled “Dynamic Claims Adjudication,” filed Oct. 27, 2010, and published May 3, 2012 as U.S. Patent Publication No. 2012/0109839, which is hereby incorporated herein by reference. Additionally or alternatively, embodiments of the disclosed systems and methods may be used in conjunction with the systems and methods disclosed in U.S. patent application Ser. No. 13/207,203, entitled “System and Method for Overriding Claims,” and filed Aug. 10, 2011, the entirety of which is hereby incorporated herein by reference. Embodiments of the disclosed systems and methods may also be used in conjunction with the systems and methods disclosed in the U.S. patent application, entitled “Systems and Methods for Proactive Identification of Formulary Change Impacts,” by Momita, which was filed on the same date as the present application, the entirety of which is hereby incorporated herein by reference.

FIG. 4 is a block diagram illustrating an example wired or wireless system 550 that may be used in connection with various embodiments described herein. For example the system 550 may be used as or in conjunction with modules for generation and management of a hybrid formulary, as previously described. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the main memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A computer-implemented method of managing a hybrid formulary for claims adjudication, the method comprising, by at least one hardware processor:
receiving a plurality of source formulary components, wherein each of the plurality of source formulary components comprises at least one of one or more drug entries, one or more tiers, and one or more utilization management rules;
receiving a configuration comprising a plurality of component identifiers and one or more hierarchy rules, wherein each of the plurality of component identifiers identifies one of the plurality of source formulary components; and
applying the one or more hierarchy rules to the identified source formulary components to generate a hybrid formulary, wherein the hybrid formulary comprises at least one of a plurality of drug entries, one or more tiers, and one or more utilization management rules.

2. The method of claim 1, further comprising:
receiving a request for a claim adjudication associated with a drug;
determining a response to the request based on the hybrid formulary; and
sending the response to a recipient, wherein the response comprises either a denial or an approval.

3. The method of claim 1, wherein one or more conflicts exist between one or more of the one or more drug entries, one or more tiers, and one or more utilization management rules of two or more of the plurality of source formulary components, and wherein applying the one or more hierarchy rules comprises utilizing the one or more hierarchy rules to resolve the one or more conflicts to generate the hybrid formulary.

4. The method of claim 1, further comprising periodically applying the one or more hierarchy rules to the identified source formulary components to update the hybrid formulary.

5. The method of claim 1, further comprising:
detecting a change in one or more of the identified source formulary components; and,
in response to the detected change, applying the one or more hierarchy rules to at least the changed one or more of the identified source formulary components to update the hybrid formulary.

6. The method of claim 5, wherein the detected change comprises a change in one or more of the one or more drug entries, one or more tiers, and one or more utilization management rules of at least one of the identified source formulary components.

7. The method of claim 5, wherein the detected change comprises an addition, a change, or a removal of a component identifier to or from the plurality of component identifiers.

8. The method of claim 1, wherein the one or more hierarchy rules define one or more resolutions to one or more potential conflicts between the identified source formulary components.

9. The method of claim 8, wherein the one or more potential conflicts comprise one or more of overlapping drug entries, overlapping tiers, and overlapping utilization management rules.

10. The method of claim 1, further comprising:
receiving a second configuration comprising a second plurality of component identifiers and one or more second hierarchy rules, wherein each of the second plurality of component identifiers identifies one of the plurality of source formulary components; and
applying the one or more second hierarchy rules to the identified source formulary components in the second configuration to generate a second hybrid formulary, wherein the second hybrid formulary comprises at least one of a plurality of drug entries, one or more tiers, and one or more utilization management rules.

11. A system for managing a hybrid formulary for claims adjudication, the system comprising:
at least one hardware processor; and
at least one executable software module that, when executed by the at least one hardware processor,
receives a plurality of source formulary components, wherein each of the plurality of source formulary components comprises at least one of one or more drug entries, one or more tiers, and one or more utilization management rules,
receives a configuration comprising a plurality of component identifiers and one or more hierarchy rules, wherein each of the plurality of component identifiers identifies one of the plurality of source formulary components, and
applies the one or more hierarchy rules to the identified source formulary components to generate a hybrid formulary, wherein the hybrid formulary comprises at least one of a plurality of drug entries, one or more tiers, and one or more utilization management rules.

12. The system of claim 11, wherein the at least one executable software module further:
receives a request for a claim adjudication associated with a drug;
determines a response to the request based on the hybrid formulary; and
sends the response to a recipient, wherein the response comprises either a denial or an approval.

13. The system of claim 12, wherein one or more conflicts exist between one or more of the one or more drug entries, one or more tiers, and one or more utilization management rules of two or more of the plurality of source formulary components, and wherein applying the one or more hierarchy rules comprises utilizing the one or more hierarchy rules to resolve the one or more conflicts to generate the hybrid formulary.

14. The system of claim 11, wherein the at least one executable software module further periodically applies the one or more hierarchy rules to the identified source formulary components to update the hybrid formulary.

15. The system of claim 11, wherein the at least one executable software module further:
detects a change in one or more of the identified source formulary components; and,
in response to the detected change, applies the one or more hierarchy rules to at least the changed one or more of the identified source formulary components to update the hybrid formulary.

16. The system of claim 15, wherein the detected change comprises a change in one or more of the one or more drug entries, one or more tiers, and one or more utilization management rules of at least one of the identified source formulary components.

17. The system of claim 15, wherein the detected change comprises an addition, a change, or a removal of a component identifier to or from the plurality of component identifiers.

18. The system of claim 11, wherein the one or more hierarchy rules define one or more resolutions to one or more potential conflicts between the identified source formulary components.

19. The system of claim 18, wherein the one or more potential conflicts comprise one or more of overlapping drug entries, overlapping tiers, and overlapping utilization management rules.

20. The system of claim 11, wherein the at least one executable software module further:
receives a second configuration comprising a second plurality of component identifiers and one or more second hierarchy rules, wherein each of the second plurality of component identifiers identifies one of the plurality of source formulary components; and
applies the one or more second hierarchy rules to the identified source formulary components in the second configuration to generate a second hybrid formulary, wherein the second hybrid formulary comprises at least one of a plurality of drug entries, one or more tiers, and one or more utilization management rules.
